(19) United States
(12) Patent Application Publication
(10) Pub. No.: US 2011/0053424 A1
(43) Pub. Date: Mar. 3, 2011

(54) MEMORY CARD CONNECTOR

(76) Inventor: Wan-Tien Chen, Taipei (TW)

(21) Appl. No.: 12/546,869

(22) Filed: Aug. 25, 2009

(51) Int. Cl. H01R 24/00

(52) U.S. Cl. 439/630

(57) ABSTRACT

The present invention relates to a memory card connector, comprises an insulation main body on which an insertion slot and a plurality of terminal slots are installed, and two ends thereof are respectively provided with a tower having a guiding slot, a positioning concave slot and a limiting block, wherein the insertion slot and the guiding slot are served to be inserted with a memory card; a plurality of terminals respectively received in the plural terminal slots; and two lugs, each of the lugs has a pin shaft and a limiting part, the pin shaft is disposed in the positioning concave slot, the lug is limited in the limiting block when the lug is pivotally moved through the pin shaft so as to respectively buckle on the tower.

### BACKGROUND OF THE INVENTION

1. Field of the Invention

The present invention relates to a connector, more particularly to a memory card connector that can be used to fasten a memory card therein.

2. Description of Related Art

A memory card connector is widely used in a computer motherboard so a memory module is able to be installed therein, thus a central process unit (CPU) can access the memory module through the memory card connector. The memory card connector is such as an EDO DRAM, SDRAM, DDR DRAM and the latest DDRII RAM.

The stability of the computer mainframe relies on whether the memory module can be firmly fastened on the memory card connector. When the memory module is not able to be firmly fastened on the memory card connector, an error may occur when the computer mainframe is accessing data and a computer crash down is therefore caused.

To overcome the disadvantages mentioned above, a novel memory card connector is provided by the present invention to improve such shortages.

### SUMMARY OF THE INVENTION

One object of the present invention is to provide a memory card connector, which can be used to firmly fasten a memory module within the memory card connector.

Another object of the present invention is to provide a memory card connector, of which structure is simple and production cost is lower.

For achieving the objects mentioned above, a memory card connector is provided by the present invention, comprises an insulation main body on which an insertion slot and a plurality of terminal slots are installed, and two ends thereof are respectively provided with a tower having a guiding slot, a positioning concave slot and a limiting block, wherein the insertion slot and the guiding slot are served to be inserted with a memory card; a plurality of terminals respectively received in the plural terminal slots; and two lugs, each of the lugs has a pin shaft and a limiting part, the pin shaft is disposed in the positioning concave slot, the lug is limited in the limiting block when the lug is pivotally moved through the pin shaft so as to respectively buckle on the tower.

### BRIEF DESCRIPTION OF THE DRAWINGS

FIG. 1 is a schematic, exploded view of the memory card connector of one preferred embodiment of the present invention;

FIG. 2 is a schematic, partially-enlarged cross sectional view of the tower of one preferred embodiment of the present invention;

FIG. 3 is a schematic view of the lug of one preferred embodiment of the present invention;

FIG. 4 is a schematic view illustrating the assembly of the lug and the memory card connector of one preferred embodiment of the present invention.

### DETAILED DESCRIPTION OF THE PREFERRED EMBODIMENT

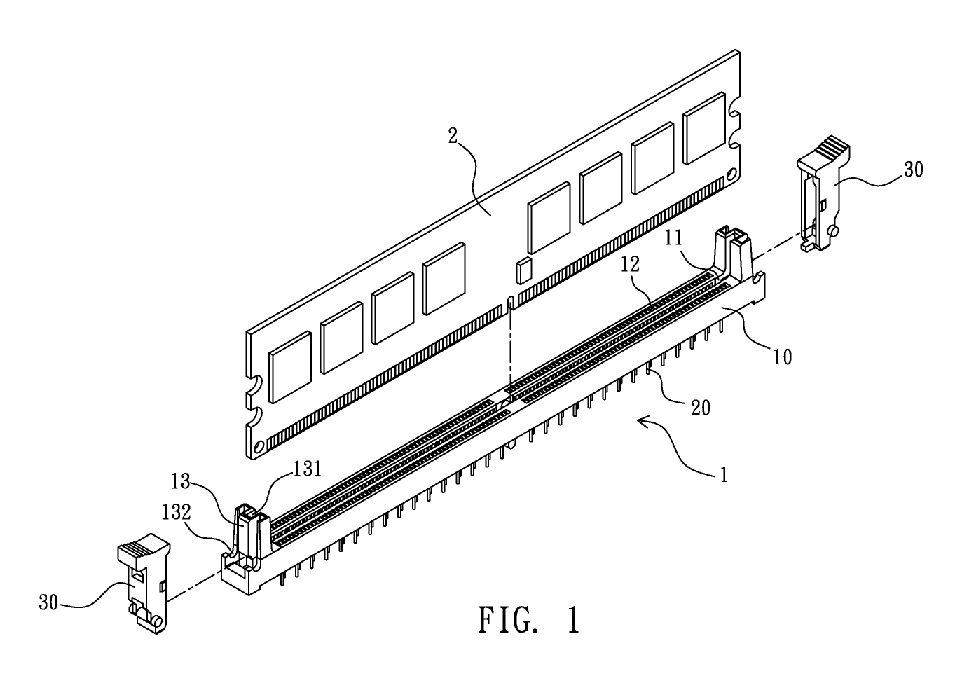

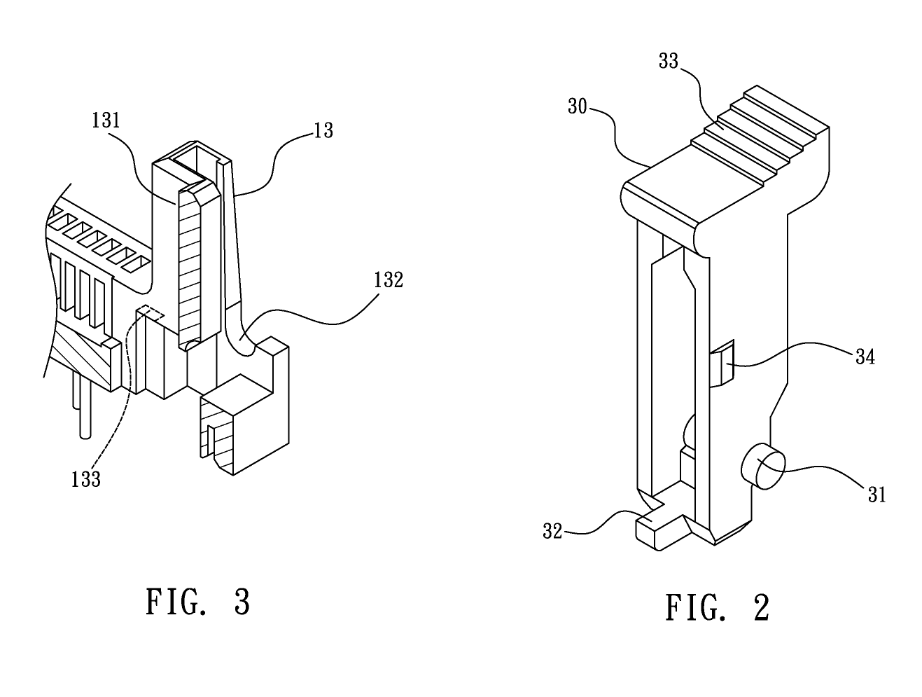

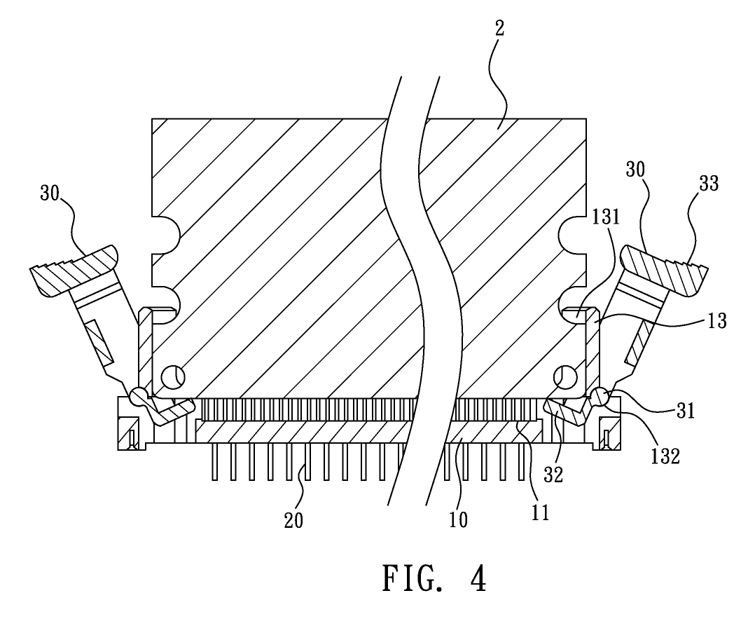

Referring from FIG. 1 to FIG. 4, wherein FIG. 1 is a schematic, exploded view of the memory card connector of one preferred embodiment of the present invention; FIG. 2 is a schematic, partially-enlarged cross sectional view of the tower of one preferred embodiment of the present invention; FIG. 3 is a schematic view of the lug of one preferred embodiment of the present invention; FIG. 4 is a schematic view illustrating the assembly of the lug and the memory card connector of one preferred embodiment of the present invention.

As shown in figures, the memory card connector 1 provided by the present invention, which can be served to connect a memory module 2, comprises an insulation main body 10, a plurality of terminals 20, and two lugs 30.

The insulation main body 10 is made of an insulation member, e.g. but not limited to, plastic, an insertion slot 11 and a plurality of terminal slots 12 are installed thereon and two ends thereof are respectively installed with a tower 13, the tower 13 has a guiding slot 131, a positioning concave slot 132 and a limiting block 133. The insertion slot 11 and the guiding slot 131 are served to be inserted with the memory module 2; the positioning concave slot 132 and the limiting block 133 are cooperated with the lugs 30.

The plural terminals 20 are respectively received in the plural terminal slots 12 so as to form an electrical connection, the terminals 20 are conventional terminals therefore would not be further illustrated.

As shown in FIG. 3, each of the two lugs 30 has a pin shaft 31 and a limiting part 32, wherein the pin shaft 31 is disposed in the positioning concave slot 132; the limiting part 32, e.g. but not limited to, protrudes from the bottom of the lug 30. The lug 30 is limited in the limiting block 133 through the limiting part 32 when the lug 30 is pivotally moved through the pin shaft 31, so the two lugs 30 are respectively buckled on the corresponding tower 13. Furthermore, the top end of the lug 30 is installed with at least one step-like transversal strip 33 to increase friction, so the tower 13 is easier to be pulled by a user.

The pin shaft 31 is disposed on top of the limiting part 32 and is in a round column shape, and protrudes from two ends of the lug 30, the pin shaft 31 is able to be received in the positioning concave slot 132 for operating a pivotal motion.

Two lateral ends of the lug 30 are further installed with a buckling block 34. The buckling block 34 is disposed at the same side where the limiting part 32 is installed and is disposed on top of the pin shaft 31, and protrudes from the two ends of the lug 30 so as to buckle on the tower 13. Two ends of the buckling block 34 respectively have a reversed angle part (not shown) and the two reversed angle parts have different angles.

As shown in FIG. 4, in assembly, the pin shaft 31 is received in the positioning concave slot 132 so as to achieve the assembly. When the lug 30 is outwardly and pivotally moved, the limiting part 32 thereof is disposed against and positioned in the limiting block 133; when the lug 30 is inwardly and pivotally moved, the limiting part 32 thereof is released from the limiting block 133 and is disposed against and positioned on one end of the tower 13, then is buckled on the tower 13 through the buckling block 34, so the memory module 2 is fastened therein.

As mentioned above, with the memory card connector provided by the present invention, the memory module can be firmly fastened in the memory card connector, and the structure of the memory card connector is simple and product cost thereof is lower.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

1-6. (canceled)

7. A memory card connector comprising:
an insulation main body having an insertion slot, a plurality of terminal slots, and two towers, one of the two towers is located on each of two opposing ends of the insulation main body, each tower of the two towers has a guiding slot, a concave positioning slot and a limiting block, the insertion slot and the guiding slot are positioned for a memory module to be inserted therein;
a plurality of terminals respectively located in the plural terminal slots; and
two lugs, each lug of the two lugs has a pin shaft extending through the lug and protruding outwardly from two opposing sides thereof and a limiting part extending outwardly from a bottom of a front thereof, two opposing ends and a center of the pin shaft are located in the concave positioning slot, the lug is limited by the limiting block when the lug is pivoted around the pin shaft to respectively buckle on the tower.

8. The memory card connector according to claim 7, wherein a top of the each lug has at least one step-like transversal strip.

9. The memory card connector according to claim 7, wherein the limiting part protrudes from a bottom of the each lug.

10. The memory card connector according to claim 7, wherein the pin shaft is located above the limiting part and has a round column shape.

11. The memory card connector according to claim 10, wherein the each lug has a buckling block located on each of the two opposing sides thereof and located adjacent to the front thereof, the each buckling block is positioned above the pin shaft, each buckling block selectively engages a corresponding one of the two towers.

12. The memory card connector according to claim 11, wherein the each buckling block has two reversed angle parts, one of the two reversed angle parts is located on each of two opposing ends of a corresponding buckling part, and the two reversed angle parts have different angles.
